(19) United States
(12) Patent Application Publication
(10) Pub. No.: US 2012/0030137 A1
(43) Pub. Date: Feb. 2, 2012

(54) METHOD AND DEVICE FOR VALUATION OF A TRADED COMMODITY

(75) Inventors: Jochen Garcke, Berlin (DE); Michael Griebel, Bonn (DE); Thomas Gerstner, Frankfurt am Main (DE)

(73) Assignee: Technische Universitat Berlin

(21) Appl. No.: 12/848,056

(22) Filed: Jul. 30, 2010

(51) Int. Cl. G06Q 40/00

(52) U.S. Cl. 705/36 R

(57) ABSTRACT

A method and device for valuation of a traded commodity

An embodiment of the invention relates to a method for valuation of a traded commodity by a data processor, wherein a relative or absolute future value of the traded commodity is computed by a determination of an expectation by the data processor, the method comprising the steps of:
receiving an historical time series indicating the commodity's value over time in the data processor;
transferring the historical time series of the commodity's value into attribute values of at least one attribute representative for internal features of the historical time series; and
constructing a function predicting the future value of the commodity based on a sparse grid regression method which takes said attribute values into account.

A method and device for valuation of a traded commodity

### BACKGROUND OF THE INVENTION

After the breakdown of the Bretton Woods system of fixed exchange rates in 1973, the forecasting of exchange rates became more and more important. Nowadays the amounts traded in the foreign exchange market are over three trillion US dollars every day. With the emergence of the Euro in 1999 as a second world currency which rivals the US dollar [27], the forecasting of FX rates got more necessary but also more complicated. Besides incorporating basic economic and financial news, reports by market analysts, and opinions expressed in financial journals, many investors and traders employ in their decision process (besides their guts feelings) technical tools to analyze the transaction data. These data consist of huge amounts of quoted exchange rates, where each new transaction generates a so-called tick, often many within a second.

Several academic studies have evaluated the profitability of trading strategies based on daily or weekly data. However, such investigations of trading in the foreign exchange market have not been consistent with the practice of technical analysis [22, 25]. Technical traders transact at a high frequency and aim to finish the trading day with a net open position of zero. In surveys of participants in the foreign exchange market, 90% of respondents use technical analysis in intraday trading [23, 30], whereas 25% to 30% of traders base most of their trades on technical signals [4]. Evidence was presented in [26] that so-called support and resistance levels, i.e. points at which an exchange rate trend is likely to be suspended or reversed, indeed help to predict intraday trend interruptions. On the other hand, the authors of [5] examined filter rules supplied by technical analysts and did not find evidence for profit. Nevertheless, the existence of profit-making rules might be explained from a statistical perspective by the more complex, nonlinear dynamics of foreign exchange rates as observed in [16]. In [6] two computational learning strategies, reinforcement learning and genetic programming, were compared to two simpler methods, a Markov decision problem and a simple heuristic. These methods were able to generate profits in intraday trading when transaction costs were zero, although none produced significant profits for realistic values. In [25], with the use of a genetic program and an optimized linear forecasting model with realistic transaction costs, no evidence of excess returns was found but some remarkable stable patterns in the data were nevertheless discovered. In [35] multiple foreign exchange rates were used simultaneously in connection with neural networks. There, better performance was observed using multiple exchange rates than in a separate analysis of each single exchange rate.

### OBJECTIVE OF THE PRESENT INVENTION

An objective of the present invention is to provide a method and system for an accurate valuation of a traded commodity.

### BRIEF SUMMARY OF THE INVENTION

An embodiment of the invention relates to a method for valuation of a traded commodity by a data processor, wherein a relative or absolute future value of the traded commodity is computed by a determination of an expectation by the data processor, the method comprising the steps of:
receiving a historical time series indicating the commodity's value over time in the data processor;
transferring the historical time series of the commodity's value into attribute values of at least one attribute representative for internal features of the historical time series; and
constructing a function predicting the future value of the commodity based on a sparse grid regression method which takes said attribute values into account.

Preferably, said step of transferring the historical time series of the commodity's value into attribute values includes generating data describing the temporal changes of the historical time series.

Said data describing the temporal changes of the historical time series may be calculated for at least two different time scales.

Said step of transferring the historical time series of the commodity's value into attribute values preferably includes calculating at least one derivative of first or higher degree of the historical time series.

Said step of transferring the historical time series of the commodity's value into attribute values may also include calculating a variance indicating the magnitude of change of the historical time series values over time.

Said step of transferring the historical time series of the commodity's value into attribute values may include calculating higher order standardized moments indicating the behavior of the change of the historical time series values over time.

Said step of transferring the historical time series of the commodity's value into attribute values may include calculating one or more moving average for a selected time window indicating the change of the historical time series values over time.

Said step of transferring the historical time series of the commodity's value into attribute values may include calculating the buy/sell spread indicating the liquidity of the market and size of the transaction cost for the traded commodity.

Said step of transferring the historical time series of the commodity's value into attribute values may include calculating one or more open-high-low-close values, which is the price range (the highest and lowest prices) over one unit of time, for a selected time window indicating the movement of the historical time series values over time.

Values of at least a second commodity may also be taken into account.

A preferred embodiment also comprises the steps of:
transferring a second historical time series of values of the second commodity into attribute values of at least one attribute representative for internal features of the second historical time series; and
constructing said function predicting the future value of the commodity based on a sparse grid regression method which further takes the attribute values of the second time series into account.

A further function describing the future value of the second commodity may be calculated based on a sparse grid regression method which takes the attribute values of the historical time series of the commodity and the attribute values of the second historical time series of the second commodity into account.

The predicted future commodity's value may be communicated as at least one of a digital signal and an analog signal, and the value is displayed on at least one of a monitor and an output device.

Said sparse grid regression function may be evaluated during processing of electronic training data, wherein a sparse grid regression function may be applied to a set of electronic evaluation data and a quality value indicating the quality of the prediction by said sparse grid regression function may be evaluated.

The future value of the commodity may be evaluated based on said sparse grid regression function if said quality value exceeds a predefined threshold.

Another embodiment of the invention relates to a method for generating a recommendation signal indicating a recommendation to buy or sell a commodity by a data processor, the method comprising the steps of:
receiving a historical time series of the commodity's value in the data processor;
transferring the historical time series of the commodity's value into attribute values of at least one attribute representative for internal features of the historical time series;
constructing a function predicting a relative or absolute future value of the commodity based on a sparse grid regression method which takes said attribute values into account; and
generating said recommendation signal if the increase or decrease of the predicted future value of the traded commodity exceeds a predefined threshold.

The invention also relates to a device. An embodiment of such a device for valuation of a traded commodity may comprise:
an input unit adapted to accept an historical time series of the commodity's value;
an output unit adapted to output a predicted relative or absolute future value of the commodity; and
a data processor configured to compute the predicted future value of the traded commodity by a determination of an expectation, based on the following steps:
   receiving the historical time series of the commodity's value from the input unit;
   transferring the historical time series of the commodity's value into attribute values of at least one attribute representative for internal features of the historical time series; and
   constructing a function predicting the future value of the commodity based on a sparse grid regression method which takes said attribute values into account.

### BRIEF DESCRIPTION OF THE DRAWINGS

In order that the manner in which the above-recited and other advantages of the invention are obtained will be readily understood, a more particular description of the invention briefly described above will be rendered by reference to specific embodiments thereof which are illustrated in the appended figures and tables. Understanding that these figures and tables depict only typical embodiments of the invention and are therefore not to be considered to be limiting of its scope, the invention will be described and explained with additional specificity and detail by the use of the accompanying drawings in which

FIG. 1 shows grids employed by the combination technique of level L=4 in two dimensions;

FIG. 2 comprises a table showing the total and missing number of ticks, number of gaps, and maximum and average gap length of the input data;

FIG. 3 shows the realized potential rp for the currency pair EUR/USD for all predictions (left) and for the 5% ticks with the strongest predictions (right), L=4 and λ=0.0001;

FIG. 4 comprises a table showing 3-fold cross-validation results for the forecast of EUR/USD using \hat{k}k=15 and the feature [symbol] ₉′ for varying refinement level L and regularization parameter λ;

FIG. 5 comprises a table showing 3-fold cross-validation results for the forecast of EUR/USD using \hat{k}=5 and the feature [symbol] ₉′ and [symbol] ₄′ for varying refinement level L and regularization parameter λ;

FIG. 6 comprises a table showing the forecast of the EUR/USD for \hat{k}=15 on the 10% remaining test data using first derivatives of the EUR/USD exchange rate;

FIG. 7 shows the prediction accuracy and the realized potential on the training data for the fixed-length moving average trading strategy for \hat{k}=15 and varying lengths of the moving averages;

FIG. 8 comprises a table showing a 3-fold cross-validation results for the forecast of EUR/USD using \hat{k}=15 and features derived from different exchange rates for varying refinement level L and regularization parameter λ;

FIG. 9 comprises a table showing a forecast of EUR/USD for \hat{k}=15 on the 10% remaining test data using one first derivative from multiple currency pairs, wherein the results are for trading on all signals and on signals >10₋₄;

FIG. 10 comprises a table showing a forecast of EUR/USD 15 ticks into the future using multiple currency pairs and derivatives on the 10% remaining test data, wherein the results are for trading on all signals and on signals >10₋₄.

FIG. 11 comprises a table showing cp-values per trade for the forecast of EUR/USD for \hat{k}=15 using different attribute selections on the 10% remaining test data;

FIG. 12 comprises a table showing cp-values per trade for the forecast of EUR/USD for \hat{k}=15 using the trading strategy with opening and closing thresholds on the 10% remaining test data; and

FIG. 13 shows an exemplary embodiment of a device for valuation of a traded commodity.

### DETAILED DESCRIPTION OF THE PREFERRED EMBODIMENT

The preferred embodiment of the present invention will be best understood by reference to the drawings, wherein identical or comparable parts are designated by the same reference signs throughout.

It will be readily understood that the present invention, as generally described herein, could vary in a wide range. Thus, the following more detailed description of the exemplary embodiments of the present invention, is not intended to limit the scope of the invention, as claimed, but is merely representative of presently preferred embodiments of the invention.

In the following we show in an exemplary fashion how the historical intraday exchange rate data are given and discuss how we can convert the FX forecast problem into a regularized least squares regression problem in a high-dimensional space by delay embedding.

Input Data Foreign exchange rate tick data consist of the bid and ask quotes of market participants recorded by electronic transaction systems. Note that the tick data are not the real transaction prices for this market, but only the quotes at which market participants want to trade. This results in a small uncertainty in the data. Nevertheless, exchange rate data is presented in this form by most financial news agencies like e.g. Reuters or Bloomberg. Such historical data are collected and sold by these agencies and other data vendors. For example, in the year 2002 the database of Olsen Data has recorded more than 5 million ticks for the EUR/USD exchange rate—the most heavily traded currency pair—which gives about 20,000 ticks per business day. The bid and ask prices are typically converted to midpoint prices: ½ (bid price+ask price). Note that the spread, that is the difference between bid and ask prices, has to be included in the analysis of the performance at some point in order to assess the expected trading efficiency of a forecasting tool.

In the following we assume that for each tick we have the date, time and one exchange rate value, the midpoint. The raw data of each considered currency pair therefore looks like

| | | |
|---|---|---|
| Sep. 06, 2002 | 09:18:54 | 0.95595 |
| Sep. 06, 2002 | 09:18:55 | 0.95615 |
| Sep. 06, 2002 | 09:18:58 | 0.95585 |
| Sep. 06, 2002 | 09:18:59 | 0.95605 |
| Sep. 06, 2002 | 09:19:11 | 0.95689. |

Now the raw tick data are interpolated to equidistant points in time with a fixed distance of τ. Data from the future cannot be used, therefore the value at the latest raw tick is employed as the exchange rate at these points, i.e. piecewise constant upwind interpolation is applied. If the latest raw tick is more then τ in the past, which means it is the one used for the interpolated tick at the position before, the exchange rate is set to “nodata”. Furthermore, for all currency pairs the same positions in time are taken. Some data providers already offer such mapped data in addition to the raw data. This way, given J data points from R currency pairs, the input data for exchange rate forecasting has the form

{t₁, fᵣ(tⱼ)} for j=1, . . . , J and r=1, . . . , R.

Here, tⱼ denotes the j-th point in time, fᵣ denotes the exchange rate of the r-th currency pair and tⱼ+1=tⱼ+τ. Note here that, for reasons of simplicity, we furthermore assume that the nominal differences between the interest rates for the currencies are constant and therefore do not need to be taken into account.

Delay Embedding into a Feature Space

Based on these interpolated historical input data consisting of J•R data points we now want to predict the value or trend of the exchange rate of the first currency pair f₁. Given a point in time tⱼ we want to forecast the trend for f₁ at some time tⱼ+\hat{k}_{τ} in the future. To this end, we convert the given series of transaction information up to time tⱼ into data in a D-dimensional feature space, also called attribute space, which is supposed to describe the market situation at time tⱼ. The D-dimensional vector in feature space is put together by delay embedding the given tick data (see, for example, [7, 19, 21]). For each exchange rate fᵣ we consider a fixed number K of delayed values

fᵣ(tⱼ), fᵣ(tⱼ−τ), fᵣ(tⱼ−2τ), . . . , fᵣ(tⱼ−(K−1)τ),

where K defines our time horizon [tⱼ−(K−1)τ, tⱼ] backward in time. The resulting R•K delayed values could be directly used to give the D-dimensional feature space with f₁(t) being the first coordinate, f₁(t−τ) the second, and so on up to f_{R}(t−(K−1)τ) being the (R•K)-th coordinate.

Note that this is not the only way of delay embedding the data for time tⱼ. Instead of directly employing the exchange rates, (discrete) first derivatives

f_{r,k}′(tⱼ):=(fᵣ(tⱼ)−fᵣ(tⱼ−kτ))/kτ

with k=1, . . . , K−1 can be used in our backward time horizon yielding K−1 coordinates for each exchange rate and R(K−1) coordinates in total. Normalized first derivatives

$${\tilde{f}}_{r , k}^{′} ( {t}_{j} ) := \frac{{f}_{r} ( {t}_{j} ) - {f}_{r} ( {t}_{j} - {k}_{τ} )}{k τ {f}_{r} ( {t}_{j} - k τ )}$$

can be considered as well, this takes the assumption into account that trading strategies look for relative changes in the market and not absolute ones. Alternatively, a combination of exchange rates, first derivatives, higher order derivatives or statistically derived values like variances or frequencies can be employed as attributes. Note that the actual use of a given feature at all time positions of our backward time horizon of size K, e.g. all K values of the exchange rates or all K−1 values of the first derivative, is usually not necessary. A suitable selection from the possible time positions of a given attribute in the time horizon [tⱼ−(K−1)τ, tⱼ], or even only one, can be enough in many situations.

In any case, the number of features obtained by the delay embedding can easily grow large. Therefore, the number K of delay values, that is the size of our backward time horizon, and the total number of derived attributes D have to be chosen properly from the large number of possible embedding strategies. A good choice of such derived attributes and their parameters is non-trivial and has to be determined by careful experiments and suitable assumptions on the behaviour of the market.

In general, the transformation into feature space, i.e. the space of the embedding, for a given point in time tⱼ is an operator

T: [symbol] ^{R·K}→ [symbol] ^{D}

y(tⱼ)=(f₁(tⱼ), . . . , f₁(tⱼ−(K−1)τ). f₂(tⱼ), . . . , f₂(tⱼ−(K−1)τ), . . . , f_{R}(tⱼ), . . . , f_{R}(tⱼ−(K−1)τ))

with the feature vector

x(tⱼ)=(x₁, . . . x_{D})∈ [symbol] ^{D}

where the single features x_{d}, d=1, . . . , D, are any of the derived values mentioned.

As the response variable in the machine learning process we employ the normalized difference between the exchange rate f₁ at the current time tⱼ and at some time tⱼ+\hat{k}τ in the future, i.e.

$$y ( {t}_{j} ) = \frac{{f}_{1} ( {t}_{j} + \hat{k} τ ) - {f}_{1} ( {t}_{j} )}{{f}_{1} ( {t}_{j} )} ..$$

This will give a regression problem later on. If one is only interested in the trend, the sign of y(tⱼ) can be used as the response variable which will result in a classification problem.

This transformation of the transaction data into a D-dimensional feature vector can be applied at J−(K−1)−k different time points tⱼ over the whole data series, since at the beginning and end of the given time series data one has to allow for the time frame of the delay embedding and prediction, respectively. Altogether, the application of such an embedding transformation and the evaluation of the associated forecast values over the whole time series results in a data set of the form

S={(xₘ, yₘ)∈ [symbol] ^{D}× [symbol] }ₘ₌₁^{J-(K-1)-\hat{k}}.

With xₘ=x(t_{m+K-1}) and yₘ=y(t_{m+K-1}). (1)

This dataset can now be used by any machine learning algorithm, such as neural networks, multivariate adaptive regression splines or support vector machines, to construct a function

u: Ω ⊂ [symbol] ^{D}→

[symbol]

which describes the relationship between the features x, i.e. the market situation, and the response y, i.e. the trend.

This relationship can then be evaluated at a future time t by using the same operator T to transform its corresponding transaction data into a D-dimensional feature vector x which describes this new market situation. Since we assume that the market behaves similarly in similar situations, the evaluation of the reconstructed continuous function u in such a new market situation x is supposed to yield a good prediction

Regularized Least Squares Regression

In the following we formulate the scattered data approximation problem in D-dimensional space by means of a regularization network approach [8, 13]. As stated above, we assume that the relation between x and y in the data set (1) can be described by an unknown function

u: Ω ⊂ [symbol] ^{D}→

[symbol]

which belongs to some space V of functions defined over R^{D}.

The aim is now to recover the function u from the given data S, of some size M, with e.g.

M:=J−(K−1)−\hat{k},

as good as possible. A simple least squares fit of the data would surely result in an ill-posed problem. To obtain a well-posed, uniquely solvable problem, we use regularization theory and impose additional smoothness constraints on the solution of the approximation problem. In our approach this results in the variational problem

$${min}_{u ∈ V} R ( u ) \\ R ( u ) = \frac{1}{M} {\sum }_{m = 1}^{M} {( u ( {\underline{x}}_{m} ) - {y}_{m} )}^{2} + λ {‖ Gu ‖}_{{L}_{2}}^{2} . \qquad ( 2 )$$

Here, the mean squared error enforces closeness of u to the data, the regularization term defined by the operator G enforces the smoothness of u, and the regularization parameter X balances these two terms. Other error measurements can also be suitable. Further details can be found in [8, 11, 31].

Note that there is a close relation to reproducing kernel Hilbert spaces and kernel methods where a kernel is associated to the regularization operator G, see also [28, 33].

### Sparse Grid Discretization

In order to compute a numerical solution of (2), we restrict the problem to a finite dimensional subspace V_{N}⊂V of dimension dim V_{N}=N. Common data mining methods like radial basis approaches or support vector machines work with global ansatz functions associated to data points which leads to N=M.

These methods allow to deal with very high-dimensional feature spaces, but typically scale at least quadratically or even cubically with the number of data points and, thus, cannot be applied to the huge data sets prevalent in foreign exchange rate prediction.

Instead, we use grid based local basis functions, i.e. finite elements, in the feature space, similarly to the numerical treatment of partial differential equations. With such a basis {ψn}ₙ₌₁^{N} of the function space V_{N} we can approximately represent the regressor u as

$${u}_{N} ( \underline{x} ) = {\sum }_{n = 1}^{N} {α}_{n} {ϕ}_{n} ( \underline{x} ) . \qquad ( 3 )$$

Note that the restriction to a suitably chosen finite-dimensional subspace involves some additional regularization (regularization by discretization [18]) which depends on the choice of V_{N}.

In the following, we simply choose G=∇ as the smoothing operator. Although this does not result in a well-posed problem in an infinite dimensional function space its use is reasonable in the discrete function space V_{N}, N<∞, see [11, 12].

Now we plug (3) into (2). After differentiation with respect to the coefficients αⱼ, the necessary condition for a minimum of R(u_{N}) gives the linear system of equations [11]

(λ [symbol] + [symbol] · [symbol] ^{T})α= [symbol] γ. (4)

Here C is a square N×N matrix with entries

[symbol]

_{n,n′}=M·(∇ψₙ, ∇ψ_{n′})L₂

for n, n′=1, . . . , N, and [symbol] is a rectangular N×M matrix with entries

[symbol]

_{n,m}=ψₙ(xₘ),

m=1, . . . , M, and n=1, . . . , N.

The vector y contains the response labels yₘ, m=1, . . . , M.

The unknown vector α contains the degrees of freedom αₙ and has length N. A solution of this linear system then gives the vector α which spans the approximation u_{N}(x) with (3).

### Sparse Grid Combination Technique

Up to now we have not yet been specific what finite-dimensional subspace V_{N} and what type of basis functions {ψₙ}ₙ₌₁^{N} we want to choose. If uniform grids would be used here, we would immediately encounter the curse of dimensionality and could not treat higher dimensional problems. Instead we employ sparse grid subspaces as introduced in [3, 34] to discretize and solve the regularization problem (2), see also [11]. This discretization approach is based on a sparse tensor product decomposition of the underlying function space. In the following we describe the relevant basic ideas, for details see [3, 9, 11, 34].

To be precise, we apply sparse grids in form of the combination technique [15]. There, we discretize and solve the problem on a suitable sequence of small and in general anisotropic grids Ωₗ of level l=(l₁, . . . , l_{D}), which have different but uniform mesh sizes h_{d}=2^{-ld}, d=1, . . . , D, in each coordinate direction. The points of a given grid Ωₗ are numbered using the multi-index i=(i1, . . . , i_{D}) with i_{d}∈{0, . . . 2^{1d}} for d=1, . . . , m,D. For ease of presentation, we assume the domain Ω=[0, 1]^{D} here and in the following, which can be always achieved by a proper rescaling of the data.

A finite element approach with piecewise multilinear functions

$${φ}_{\underline{l} , \underline{i}} ( \underline{x} ) := {\prod }_{d = 1}^{D} {φ}_{{l}_{d} , {i}_{d}} ( {x}_{d} ) , {i}_{d} = 0 , … , {2}^{{l}_{d}} , \qquad ( 5 )$$

on each grid Ωₗ, where the one-dimensional basis functions φl_{d},i_{d}(x_{d}) are the so-called hat functions

$${φ}_{{l}_{d} , {i}_{d}} ( {x}_{d} ) = \{ \begin{matrix}1 - \vert \frac{{x}_{d}}{{h}_{{l}_{d}}} - {i}_{d} \vert , & {x}_{d} ∈ [ ( {i}_{d} - 1 ) {h}_{{l}_{d}} , ( {i}_{d} + 1 ) {h}_{{l}_{d}} ] \\ 0 , & otherwise ,\end{matrix}$$

results in the discrete function space

Vₗ:=span{φₗ,i_{d}=0, . . . , 2^{l}^{_{d}}, d=1, . . . D}

on grid Ωₗ.

A function uₗ∈Vₗ is then represented as

$${u}_{\underline{l}} ( \underline{x} ) = {\sum }_{{i}_{1} = 0}^{{2}^{{l}_{1}}} … {\sum }_{{i}_{D} = 0}^{{2}^{l} D} {α}_{\underline{l} , \underline{i}} {φ}_{\underline{l} , \underline{i}} ( \underline{x} ) ..$$

Each multi linear function φ_{l, i}(x) equals one at the grid point i and is zero at all other points of grid Ωₗ.

Its support, i.e. the domain where the function is non-zero, is

[symbol]

_{d=1}^{D}[(i_{d}−1)hₗ_{_{d}}.(i_{d}+1)hₗ_{_{d}}],

To obtain a solution in the sparse grid space V_{L}^{s} of level L the combination technique considers all grids Ωₗ with

l₁+ . . . +l_{D}=L+(D−1)−q, q=0, . . . , D−1, l_{q}>0, (6)

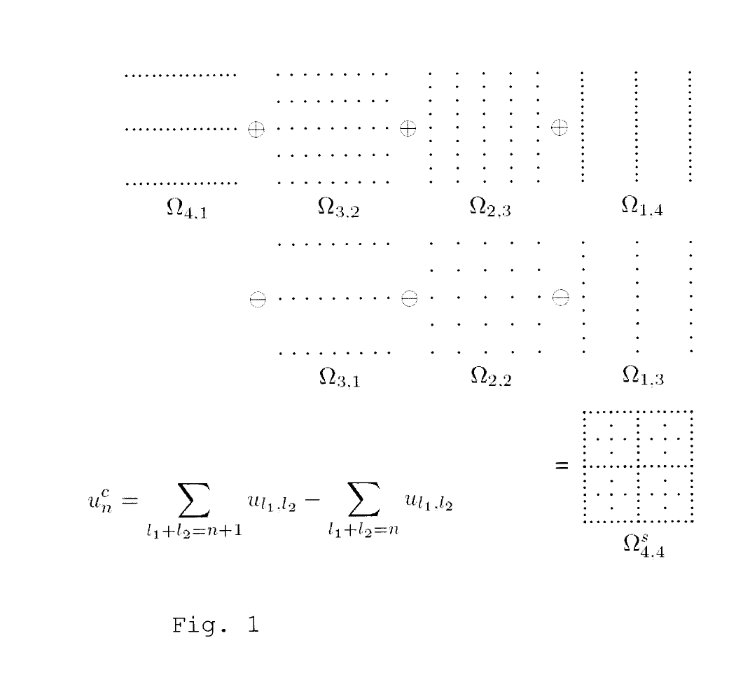

see also FIG. 1 for an example in two dimensions. FIG. 1 shows grids employed by the combination technique of level L=4 in two dimensions. One gets an associated system of linear equations (4) for each of the involved grids Ωₗ, which we currently solve by a diagonally preconditioned conjugate gradient algorithm.

The combination technique [15] now linearly combines the resuiting discrete solutions uₗ(x) from the grids Ωₗ according to the formula

$${u}_{L}^{c} ( \underline{x} ) := {\sum }_{q = 0}^{D - 1} {( - 1 )}^{q} ( \begin{matrix}D - 1 \\ q\end{matrix} ) {\sum }_{{\vert \underline{l} \vert}_{1} = L + ( D - 1 ) - q} {u}_{\underline{l}} ( \underline{x} ) .. \qquad ( 7 )$$

The resulting function u_{L}^{c} lives in the sparse grid space V_{L}^{s} which has dimension

N=dim V_{L}^{s}= [symbol] (h_{L}⁻¹(log(h_{L}⁻¹))^{D-1}),

see [3].

It therefore depends on the dimension D to a much smaller degree than a function on the corresponding uniform grid Ω_{(L, . . . , L)} whose number of degrees of freedom is [symbol] (h_{L}^{-D}). Note that for the approximation of a function u by a sparse grid function u_{L}^{c} ∈ V_{L}^{s} L the error relation

∥u−u_{L}^{c}∥L_{ₚ}= [symbol] (h²_{L} log(h_{L}⁻¹)^{D-1})

holds, provided that u fulfils certain smoothness requirements which involve bounded second mixed derivatives [3].

The combination technique can be further generalized [9, 17] to allow problem dependent coefficients.

Note that we never explicitly assemble the function u_{L}^{c} but instead keep the solutions uₗ which arise in the combination technique (6).

If we now want to evaluate the solution at a newly given data point by \tilde{x} by

\tilde{y}:=u_{L}^{c}(\tilde{x})

we just form the combination of the associated point values uₗ(\tilde{x}) according to (7). The cost of such an evaluation is of the order [symbol] (L^{D-1}).

### Numerical Results

We now present results for the prediction of intraday foreign exchange rates with our sparse grid combination technique. Our aim is to forecast the EUR/USD exchange rate. First, we use just the EUR/USD exchange rate time series as input and employ a delay embedding of this single time series. Here we compare the performance with that of a traditional trading strategy using only EUR/USD information. We then also take the other exchange rates into account and show the corresponding results. Furthermore, we present a strategy which involves trading on strong signals only to cope with transaction costs. Based on that, we finally present a trading strategy which in addition reduces the amount of invested capital. Moreover, we compare these approaches and demonstrate their properties in numerical experiments.

Experimental Data

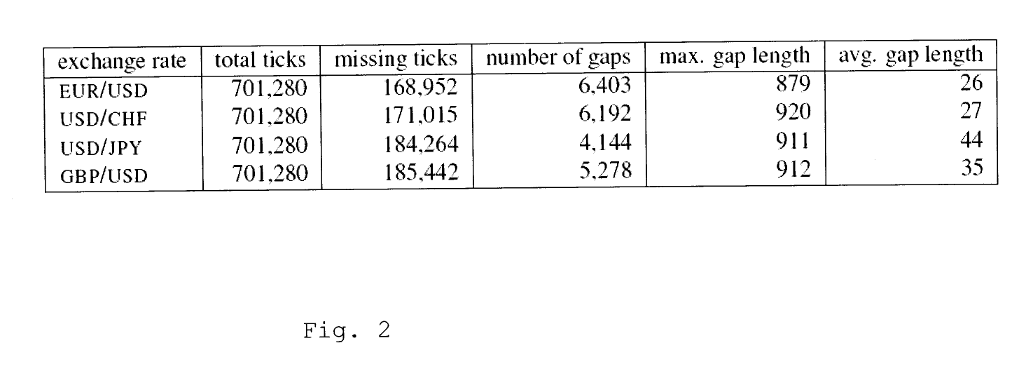

The data were obtained from Olsen Data, a commercial data provider. In the following, we employ the exchange rates from 01.08.2001 to 28.07.2005 between EUR/USD (denoted by ∈), GBP/USD (£), USD/JPY ¥ and USD/CHF (Fr.). To represent a specific currency pairing we will use the above symbols instead of fᵣ in the following. For this data set the data provider mapped the recorded raw intraday tick data by piecewise constant interpolation to values fᵣ (tⱼ) at equidistant points in time which are τ=3 minutes apart. No data is generated if in the time interval [tⱼ−τ, tⱼ] no raw tick is present. Due to this, the data set contains a multitude of gaps, which can be large when only sparse trading takes place, for example over weekends and holidays. The properties of this input data concerning these gaps is shown in FIG. 2. FIG. 2 shows that the total number of ticks in the time frame would be 701,280 for each currency pair, but between 168,000 and 186,000 ticks are missing due to the above reasons. The number of gaps varies between about 4,000 and 6,000 while the gap length varies between one and about 900 with an average of about 30. These characteristics are similar for the four currency pairs.

Note that the trading volumes are not constant during the day. The main trading starts each day in the East-Asian markets with Tokyo and Sydney as centers, then the European market with London and Frankfurt dominates, while the main trading activity takes place during the overlap of the European business hours and the later starting American market with New York as the hub [16, 20].

For the following experiments with the sparse grid regression approach the associated input data set S is obtained from the given tick data. Note that the embedding operator T at a time tⱼ depends on a certain number of delayed data positions between tⱼ−(K−1)τ and tⱼ. Typically not all time positions in the backward time horizon are employed for a given T. Nevertheless, the feature vector at time tⱼ can only be computed if the data at the positions necessary for T are present, although small data gaps in between these required points are allowed. Note here that we employ the common practice of restricting the values of outliers to a suitable chosen maximum value. Afterwards we linearly map the derived delay embedded features into [0, 1]^{D}.

In all our experiments we attempt to forecast the change in the EUR/USD exchange rate. The aim of our regression approach is to predict the relative rate difference y(tⱼ)=(∈(tⱼ+\hat{k}_{τ})−∈(tⱼ))/∈(tⱼ) at \hat{k} steps into the future (future step) in comparison to the current time. Such a forecast is often also called (trading) signal.

FIG. 2 comprises a table showing the total and missing numbers of ticks, number of gaps, and maximum and average gap length of the input data.

For the experiments we separate the available data into training data (90%) and test data (10%), this split is done on the time axis. On the training data we perform 3-fold cross-validation (again splitting in time) to find good values for the level parameter L from (7) and the regularization parameter λ from (2) of our regression approach. To this end, the training data set is split into three equal parts. Two parts are used in turn as the learning set and the quality of the regressor (see the following section) is evaluated on the remaining part for varying L and λ. The pair of values of L and λ, which performs best in the average of all three splittings is then taken as the optimum and is used for the forecast and final evaluation on the 10% remaining newest test data.

Quality Assessment

To judge the quality of the predictions by our sparse grid combination technique for a given number M of data we use the so-called realized potential

rp:=cp/mcp

as the main measurement. Here cp is the cumulative profit

$$cp := {\sum }_{m = 1}^{M} \frac{sign ( {u}_{L}^{c} ( {\underline{x}}_{m} ) ) \cdot ( {f}_{1} ( {t}_{m} + \hat{k} τ ) - {f}_{1} ( {t}_{m} ) )}{{f}_{1} ( {t}_{m} )} ,$$

i.e. the sum of the actual gain or loss in the exchange rate realized by trading at the M time steps according to the forecast of the method, while mcp is the maximum possible cumulative profit

$$mcp := {\sum }_{m = 1}^{M} \frac{\vert {f}_{1} ( {t}_{m} + \hat{k} τ ) - {f}_{1} ( {t}_{m} ) \vert}{{f}_{1} ( {t}_{m} )} ,$$

i.e. the gain when the exchange rate would have been predicted correctly for each trade. For example M=J−(K−1)−\hat{k} if we would consider the whole training data mentioned above.

Note that these measurements also take the amplitude of the potential gain or loss into account. According to practitioners, a forecasting tool which achieves a realized potential rp of 20% starts to become useful. Furthermore, we give the prediction accuracy pa, often also called hit rate or correctness rate,

$$pa := \frac{\# {\{ {u}_{L}^{c} ( {\underline{x}}_{m} ) \cdot ( {f}_{1} ( {t}_{m} + \hat{k} τ ) - {f}_{1} ( {t}_{m} ) ) > 0 \}}_{m = 1}^{M}}{\# {\{ {u}_{L}^{c} ( {\underline{x}}_{m} ) \cdot ( {f}_{1} ( {t}_{m} + \hat{k} τ ) - {f}_{1} ( {t}_{m} ) ) \neq 0 \}}_{m = 1}^{M}}$$

which denotes the percentage of correctly predicted forecasts. Prediction accuracies of more than 55% are often reported as worthwhile results for investors [1, 32]. So far, all these measurements do not yet directly take transaction costs into account. We will address this aspect later in more detail.

Forecasting Using a Single Currency Pair

In a first set of experiments we aim to forecast the EUR/USD exchange rate from the EUR/USD exchange data. We begin with using one feature, the normalized discrete first derivative

$${k}_{′}^{} = \frac{ ( {t}_{j} ) - ( {t}_{j} - k τ )}{k τ ( {t}_{j} - k τ )} ..$$

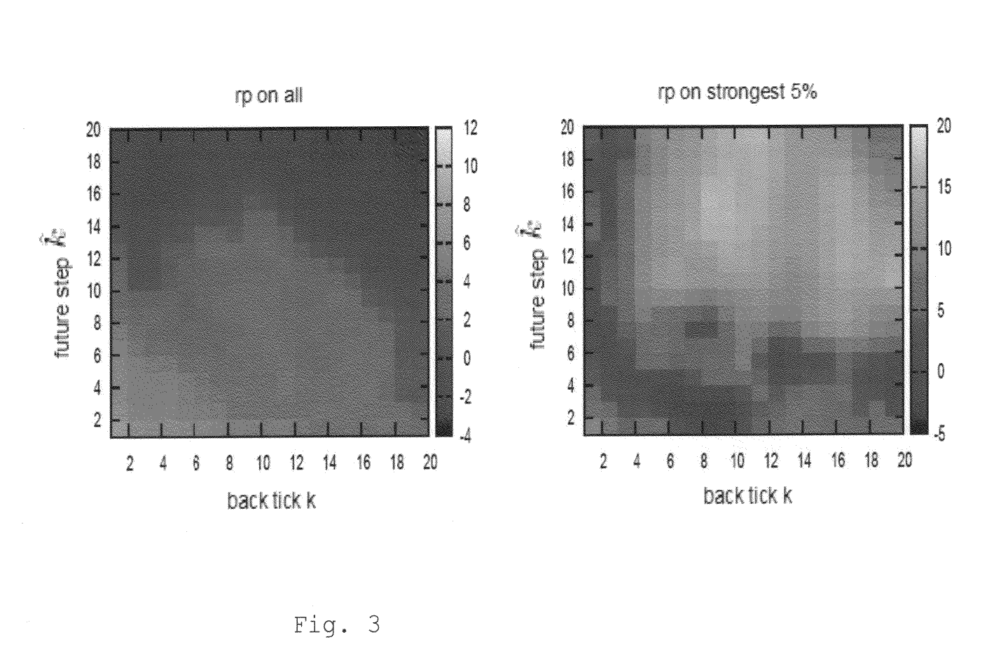

FIG. 3 shows realized potential rp for the currency pair EUR/USD for all predictions (left) and for the 5% ticks with the strongest predictions (right), L=4 and λ=0.0001.

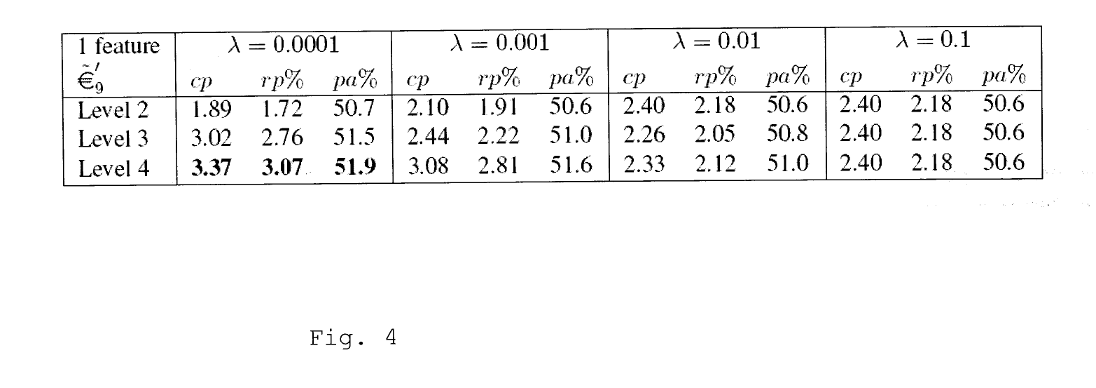

FIG. 4 shows a table with 3-fold cross-validation results for the forecast of EUR/USD using \hat{k}=15 and the feature [symbol] ₉′ for varying refinement level L and regularization parameter λ. Here, back tick k is a parameter to be determined as is \hat{k}, the time horizon for the forecast into the future. The results of experiments for the prediction of the EUR/USD exchange rate from the first derivative for several values of k and \hat{k} are shown in FIG. 3. We observe the best results for k=9 and \hat{k}=15 which we will use from now on (In particular we take here the performance on the stronger signals into account. To do that we consider the 5% ticks for which we obtain the strongest predictions). Since we consider a single currency pair we obtain just a one-dimensional problem here.

The combination technique then falls back to conventional discretization.

In FIG. 4 the table gives the results of the 3-fold cross-validation on the training data for several λ and L. We observe the highest rp for λ=0.0001 and L=4. Using these parameters we now learn on all training data. The evaluation on the remaining 10% test data then results in cp=0.741, rp=2.29%, and pa=51.5% on 51,056 trades. Of course, such small values for rp and pa are far from being practically relevant. Therefore we investigate in the following different strategies to improve performance. We start by adding an additional feature. To this end, we consider a two-dimensional regression problem where we take—besides [symbol] ₉′—the normalized first derivative [symbol] ₄′ as the second attribute. We choose the value k=4 for the back tick since the combination with the first derivative [symbol] ₉′ can be interpreted as an approximation to a normalized second derivative

$${k}_{′′}^{} = \frac{ ( {t}_{j} ) - 2 ( {t}_{j} - k τ ) + ( {t}_{j} - 2 k τ )}{{( k τ )}^{2} ( {t}_{j} - k τ )}$$

with k=4. The use of two first derivatives [symbol] ₉′ and [symbol] ₄′ captures more information in the data than just the second derivative would.

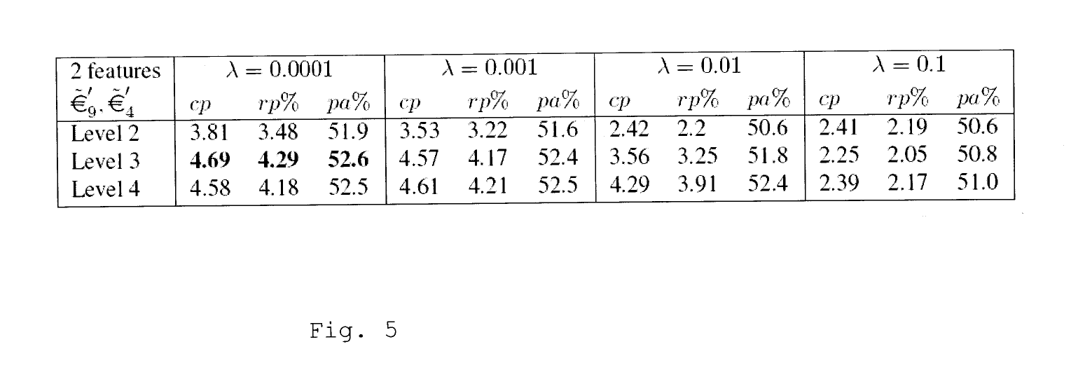

FIG. 5 shows 3-fold cross-validation results for the forecast of EUR/USD using \hat{k}=15 and the features [symbol] ₉′ and [symbol] ₄′ for varying refinement level L and regularization parameter λ.

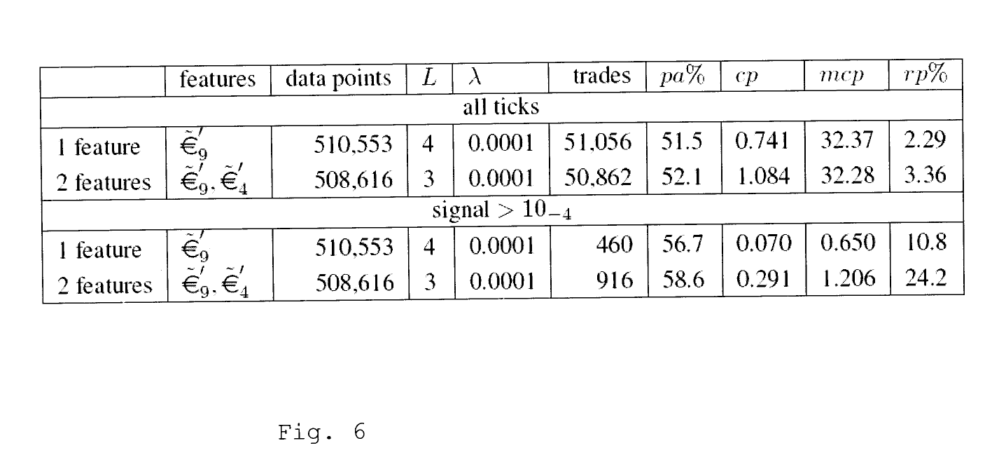

FIG. 6 shows a table comprising a forecast of the EUR/USD for \hat{k}=15 on the 10% remaining test data using first derivatives of the EUR/USD exchange rate.

The results from the 3-fold cross-validation on the training data are shown in FIG. 5. Again we pick the best parameters and thus use λ=0.0001 and L=3 for the prediction on the 10% remaining test data. The additional attribute [symbol] ₄′ results in a significant improvement of the performance: We achieve cp=1.084, rp=3.36%, and pa=52.1% on 50862 trades, see also FIG. 6 for the comparison with the former experiment using only one feature. In particular we observe that rp grows by about 50%. Furthermore, we observe that the profit is to a significant degree in the stronger signals. If we only take predictions into account which indicate an absolute change larger than 10₋₄ (Observe that a change of 10₋₄ in our target attribute is roughly the size of a pip (the smallest unit of the quoted price) for EUR/USD.), we trade on 916 signals and achieve cp=0.291, rp=24.2% and pa=58.6%, see FIG. 6. Thus, trading on 1.8% of the signals generates 26.8% of the overall profit. Note again that a rp-value of more than 20% and a pa-value of more than 55% is often considered practically relevant. Therefore trading on the stronger signals may result in a profitable strategy. Nevertheless, the use of just two features is surely not yet sufficient.

Before we add more features we need to put the performance of our approach into context. To this end, we compare with results achieved by the moving average-oscillator, a widely used technical trading rule [2]. Here buy and sell signals are generated by two moving averages, a long-period average xₗ and a short-period average xₛ. They are computed according to

$${x}_{\{ s , l \}} ( {t}_{j} ) = \frac{1}{{w}_{\{ s , l \}}} {\sum }_{i = 0}^{{w}_{\{ s , l ]} - 1} ( {t}_{j - i} ) ,$$

where the length of the associated time intervals is denoted by wₗ and wₛ, respectively. To handle small gaps in the data, we allow up to 5% of the tick data to be missing in a time interval when computing an average, which we scale accordingly in such a case. Furthermore we neglect data positions in our experiments where no information at time tⱼ, or tⱼ+τ\hat{k} is present.

In its simplest form this strategy is expressed as buying (or selling) when the short-period moving average rises above the long-period moving average by an amount larger than a prescribed band-parameter b, i.e.

xₛ(tⱼ)>b·xₗ(tⱼ)

(or falls below it, i.e. xₛ(tⱼ)<(2−b)·x₁(tⱼ)). This approach is called variable length moving average. The band-parameter b regulates the trading frequency.

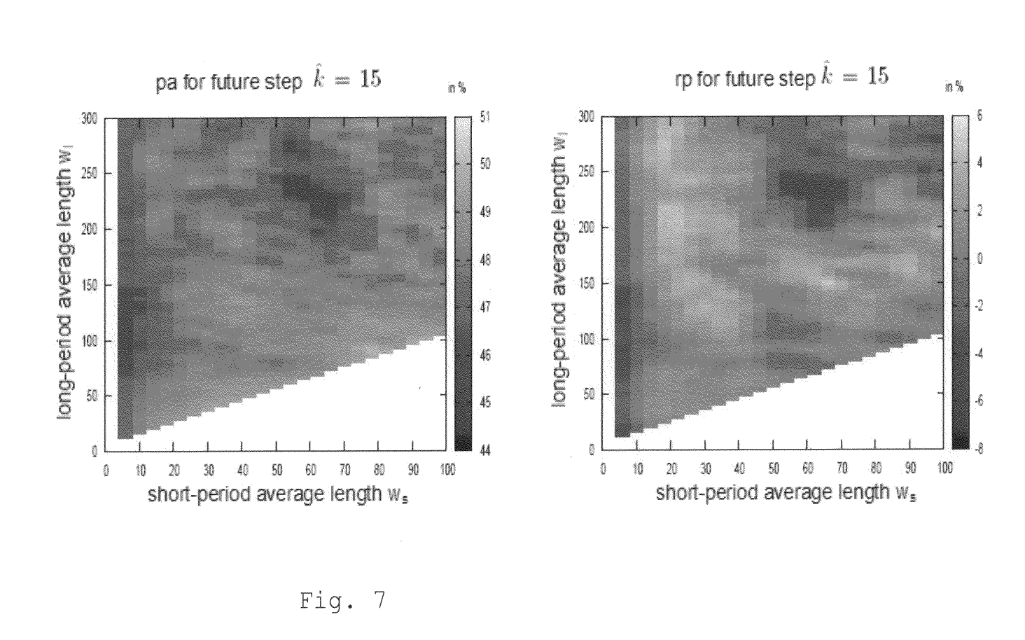

FIG. 7 shows the prediction accuracy and the realized potential on the training data for the fixed-length moving average trading strategy for \hat{k}=15 and varying lengths of the moving averages.

This conventional technical trading strategy is typically used for predictions on much longer time frames and did not achieve any profitable results in our experiments. Therefore we considered a different moving average strategy which performed better. Here, a buy signal is generated as above at time tⱼ when xₛ(tⱼ)>b·x₁(tⱼ), but a trade only takes place if xₛ(tⱼ−1)≧b·x₁(tⱼ−1) holds as well. Such a position is kept for a number \hat{k} of time steps and is then closed. In the same way, sell signals are only acted upon if both conditions (with reversed inequality sign) are fulfilled. Here, several positions might be held at a given time. This rule is called fixed-length moving average (FMA) and stresses that returns should be stable for a certain time period following a crossover of the long- and short-period averages [2].

In FIG. 7 we give the results for FUR/USD of the fixedlength moving average technical rule on the training data. Here, we vary the intervals for both the long-period and the short-period average while using a fixed time horizon in the future of \hat{k}=15. We use the prediction at 15 time steps into the future for two reasons: First we want to be able to compare the results with that of our other experiments which employ the same time horizon, and, second, this value turned out to be a very good choice for the FMA trading rule. As the parameters which achieve the highest rp on the training data we found wₛ=20, wₗ=216 and b=1.000001.

With these values we obtain cp=0.026, rp=9.47%, and pa=47.4% on the remaining 10% test data using a total of 414 trades. Although the rp with FMA is higher in comparison to the results of our approach when trading on all signals in the test data (compare with the first two rows of FIG. 6), much less trading takes place here. This small amount of trading is the reason for the quite tiny cp for FMA which is almost 40 times smaller. In addition the prediction accuracy for the signals where trading takes place is actually below 50%. But if we compare the results of FMA with our approach which acts only on the stronger signals >10₋₄ we outperform the FMA strategy on all accounts (compare with the last two rows of FIG. 6).

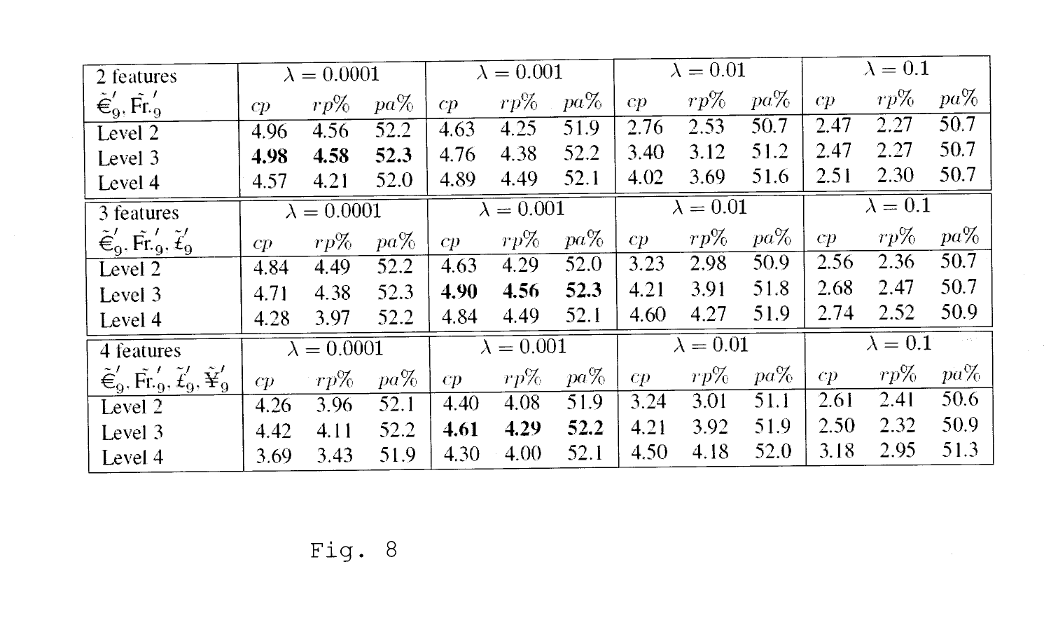

FIG. 8 shows 3-fold cross-validation results for the forecast of EUR/USD using \hat{k}=15 and features derived from different exchange rates for varying refinement level L and regularization parameter λ. Results for just [symbol] ₉′ are given in FIG. 4.

Forecasting Using Multiple Currency Pairs

Now we are interested in the improvement of the prediction of the EUR/USD exchange rate if we also take the other currency pairs £, ¥, and Fr. into account. This results in a higher-dimensional regression problem. We employ first derivatives using the same back ticks as before for the different currency pairs (Different back ticks might result in a better performance, but we restricted our experiments to equal back ticks for reasons of simplicity). Note that the number of input data points decreases slightly when we add further exchange rate pairs since some features cannot be computed any longer due to overlapping gaps in the input data.

For now we only consider the first derivatives for k=9 to observe the impact due to the use of additional currency pairs. According to the best rp we select which of the three candidates \tilde{F}\tilde{r}.₉′, \tilde{£}₉′, \tilde{¥}₉′is successively added. For example \tilde{F}\tilde{r}.₉′ in addition to [symbol] ₉′ gave the best result using two currency pairs to predict EUR/USD. We then add \tilde{£}₉′ before using \tilde{¥}₉′. As before, we select the best parameters L and for each number of features according to the rp achieved with 3-fold cross-validation on the training data, see FIG. 8. Note that the values of L and λ with the best performance do not vary much in these experiments. This indicates the stability of our parameter selection process.

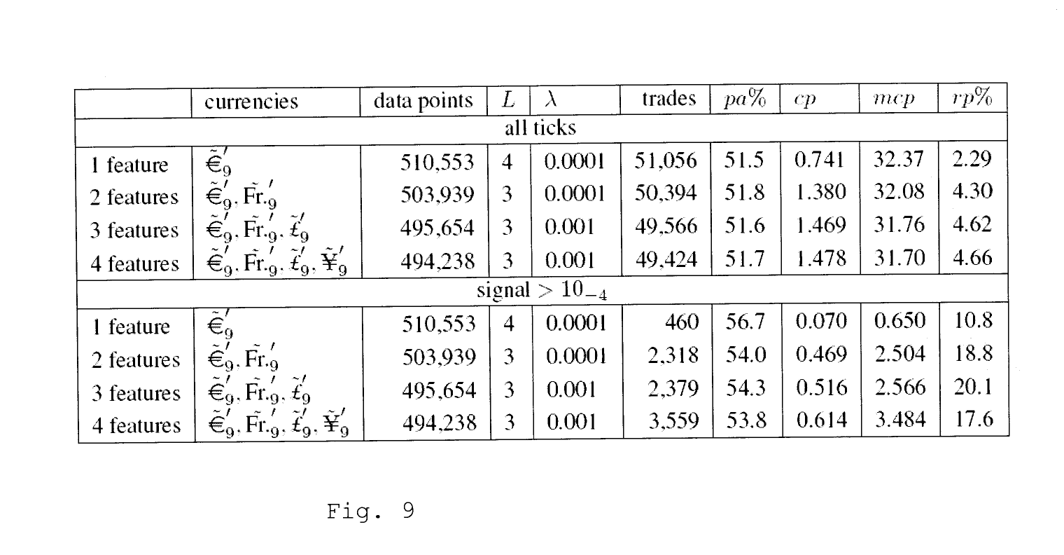

Using the combination with the best performance in the 3-fold cross-validation we then learn on all training data and evaluate on the before unseen test data. The results on the training data are given in FIG. 9, both for the case of all data and again for the case of absolute values of the signals larger than 10₋₄. Note that the performance on the training data in FIG. 8 suggests to employ the first two or three attributes. In any case, the use of information from multiple currencies results in a significant improvement of the performance in comparison to just using one attribute derived from the exchange rate to be predicted. The results on the test data given in FIG. 9 confirm that the fourth attribute \tilde{¥}₉′ does not achieve much of an improvement, whereas the additional features \tilde{F}\tilde{r}.₉′, \tilde{£}₉′ significantly improve both cp and rp. Trading on signals larger than 10₋₄ now obtains a pa of up to 56.7% and, more importantly, rp=20.1% using three attributes. This clearly shows the potential of our approach. Altogether, we see the gain in performance which can be achieved by a delay embedding of tick data of several currencies into a higher dimensional regression problem while using a first derivative for each exchange rate.

In a second round of experiments we use two first derivatives with back ticks k=9 and k=4 for each exchange rate. We add step-by-step the different currencies in the order of the above experiment from FIG. 9. To be precise, we use \tilde{F}\tilde{r}₉′ before \tilde{F}\tilde{r}.₄′, but both before \tilde{£}₉′, \tilde{£}₄′, etc (Note that a different order might result in a different performance). We thus obtain a higher dimensional regression problem. Again we look for good values for λ and L via 3-fold cross-validation.

In FIG. 9 a table comprising a forecast of EUR/USD for \hat{k}=15 on the 10% remaining test data using one first derivative from multiple currency pairs. Results are for trading on all signals and on signals >10₋₄ is shown.

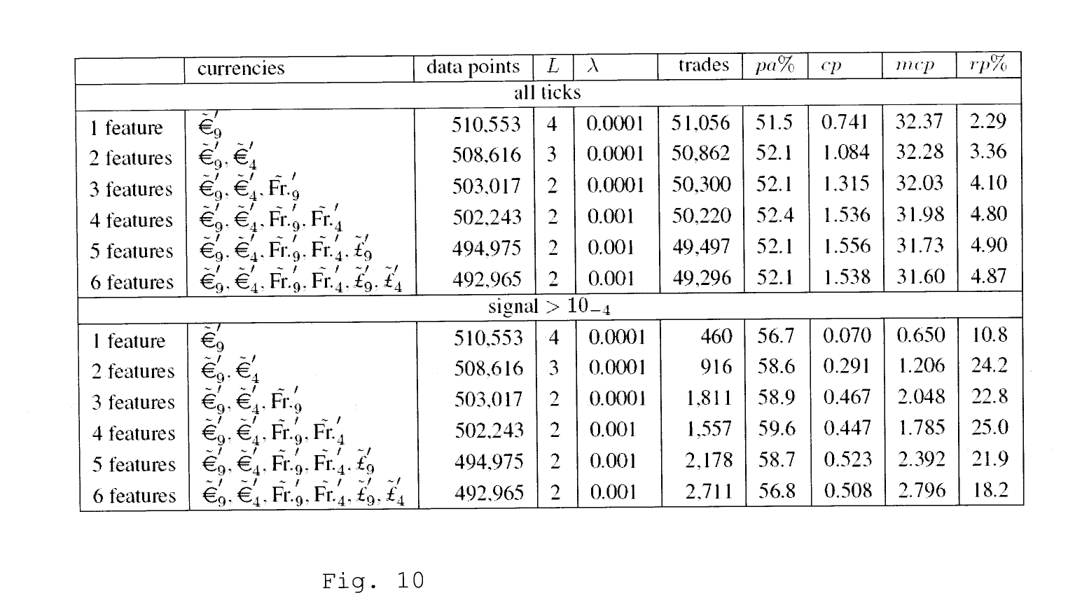

In FIG. 10 we give the results which were achieved on the test data. Note that the numbers obtained on the training data suggest to use the four features [symbol] ₉′, [symbol] ₄′, \tilde{F}\tilde{r}.₉′, \tilde{F}\tilde{r}.₄′ only; nevertheless we show the test results with the two additional features \tilde{£}₉′, \tilde{£}₄′, as well. Again, the use of information from multiple currencies gives an improvement of the performance in comparison to the use of just the attributes which were derived from the EUR/USD exchange rate. In particular cp grows from one to several currencies. With four features based on two first derivatives for each currency pair we now achieve a somewhat better performance for all trading signals than before using several first derivatives, compare tables in FIG. 9 and FIG. 10. We obtain rp=4.80 for four attributes in comparison to rp=4.62 with three attributes. The results on the stronger signals are also improved, we now achieve rp=25.0% in comparison to rp=20.1%.

Towards a Practical Trading Strategy

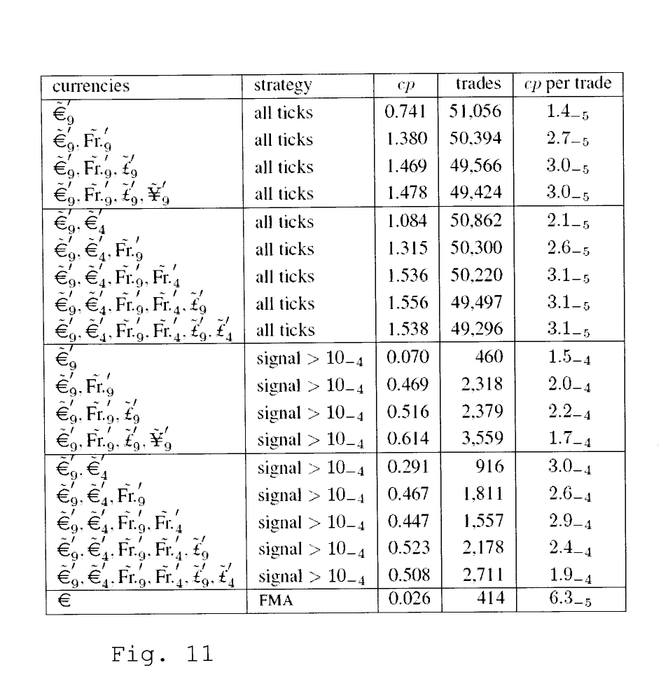

For each market situation x present in the test data, the sparse grid regressor u_{L}^{s}(x) yields a value which indicates the predicted increase or decrease of the exchange rate f₁. So far, trading on all signals showed some profit. But if one would include transaction costs this approach would no longer be viable, although low transaction costs are nowadays common in the foreign exchange market. Most brokers charge no commissions or fees whatsoever and the width of the bid/ask spread is thus the relevant quantity for the transaction costs. We assume here for simplicity that the spread is the same whether the trade involves a small or large amount of currency. It is therefore sufficient to consider the profit per trade independent of the amount of currency. Consequently, the average profit per trade needs to be at least above the average spread to result in a profitable strategy. This spread is typically five pips or less for EUR/USD and can nowadays even go down to one pip during high trading with some brokers. Note that in our case one pip is roughly equivalent to a change of 8.5₋₅ of our normalized target attribute for the time interval of the test data with an EUR/USD exchange rate of about 1.2. If the average cp per trade is larger than this value one has a potentially profitable trading strategy. In FIG. 11 we give this value for the different experiments of the previous section. We see that trading on all signals results in values which are below this threshold. The same can be observed for FMA (Furthermore only relatively few trades take place with FMA which makes this a strategy with a higher variance in the performance). However, trading on the strongest signals results in a profitable strategy in the experiments with more attribute combinations. For example, the use of \tilde{£}₉′, \tilde{£}₄′, results in 3.0₋₄ cp per trade, [symbol] ₉′, [symbol] ₄′, \tilde{F}\tilde{r}.₉′, \tilde{F}\tilde{r}.₄′ gives 2.9₋₄ cp per trade and [symbol] ₉′, \tilde{F}\tilde{r}.₉′, \tilde{£}₉′ achieves 2.2₋₄ cp per trade. But note that with this strategy one might need to have more than one position open at a given time, which means that more capital is involved. This number of open positions can vary between zero and \hat{k}. It is caused by the possibility of opening a position at all times between tⱼ and tⱼ+\hat{k}_{τ}, when the first position opened at time tⱼ is closed again. We observed in our experiments \hat{k} as the maximum number of open positions even when only trading on the stronger signals. This also indicates that a strong signal is present for a longer time period.

In FIG. 10 a forecast of EUR/USD 15 ticks into the future using multiple currency pairs and derivatives on the 10% remaining test data. Results are for trading on all signals and on signals >10₋₄ is shown.

FIG. 11 comprises a table which shows cp per trade the forecast of EUR/USD for \hat{k}=15 using different attribute selections on the 10% remaining test data.

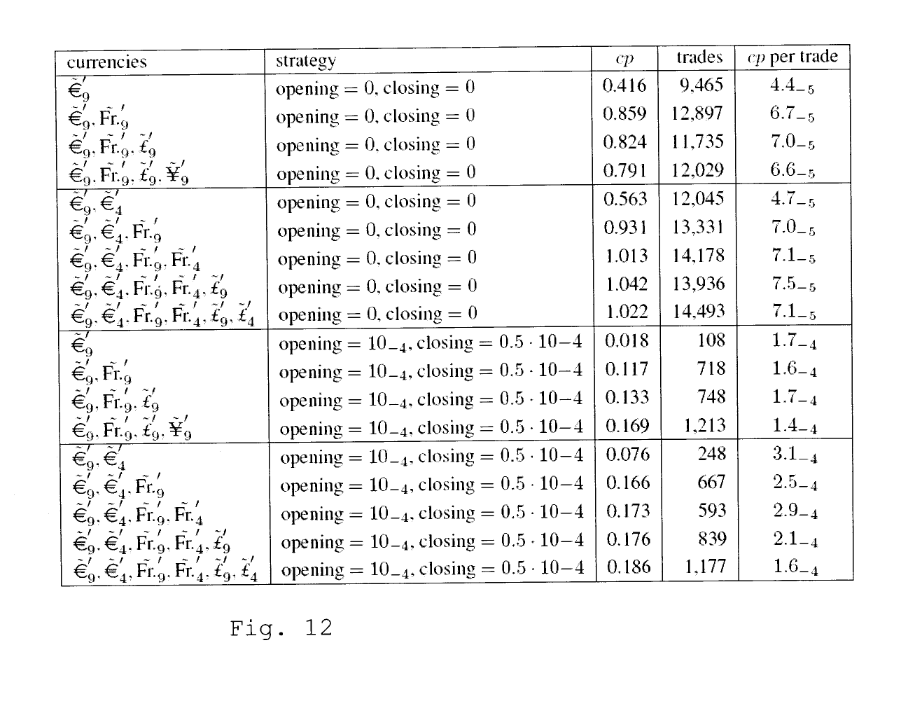

FIG. 12 shows a table comprising cp per trade for the forecast of EUR/USD for \hat{k}=15 using the trading strategy with opening and closing thresholds on the 10% remaining test data.

To avoid the need for a larger amount of capital we also implement a tradeable strategy where at most one position is open at a given time. Here one opens a position if the buy/sell signal at a time tⱼ for a prediction at \hat{k} time steps into the future is larger—in absolute values—than a pre-defined opening threshold, and no other position is open. The position is closed when a prediction in the opposite direction occurs at some time tₑ in the time interval [tⱼ, tⱼ+τ\hat{k}] and the absolute value of that prediction is greater than a prescribed closing threshold. At the prediction time tⱼ+τ\hat{k} the position is closed, unless a trading signal in the same direction as that of the original prediction is present which is larger than the opening threshold. The latter condition avoids an additional, but unnecessary trade. Furthermore, the closing at the forecast time tⱼ+τ\hat{k} avoids an open position in situations with no trading activity and where no signals can be generated.

When both of the above thresholds are zero the proposed new strategy is acting on all ticks, but at most one position is open at any given time. Besides the reduction in invested capital this strategy also improves the performance with respect to the cp per trade, see top half of the table in FIG. 12. In comparison to trading on all ticks this strategy improves the results by more than a factor of two while only considering, but not acting on all ticks. Altogether, this strategy is getting close to the profitable threshold of one pip, i.e. 8.5₋₅ in our scaling, but it is still not yet creating a true profit.

However, as observed before, a large part of the profit is generated by acting only on the strong signals. We now set for our new strategy the opening threshold to 10₋₄ and the closing threshold to 0.5·10₋₄. This adaption of our strategy achieves results which are comparable to the trading on the strong signals only. Since at most one position is open, less capital is involved than in the case of trading on all strong signals. In the bottom half of the table in FIG. 12 we give the corresponding results. We see that the cp per trade is now always above the threshold 8.5-5. The highest cp per trade is 3.1₋₄, where 248 trades take place while using [symbol] ₉′, [symbol] ₄′. For the attributes. [symbol] ₉′, [symbol] ₄′, \tilde{F}\tilde{r}.₉′, \tilde{F}\tilde{r}.₄′ we achieve 2.9₋₄ cp per trade while acting 593 times. This might be preferable due to the larger number of trades which should lead to more stable results. Thus, we finally obtained a profitable strategy, which promises a net gain of more than one pip per trade if the spread is less than two pips.

### CONCLUSIONS

We presented a machine learning approach based on delay embedding and regression with the sparse grid combination technique to forecast the intraday foreign exchange rates of the EUR/USD currency pair. It improved the results to take not only attributes derived from the EUR/USD rate but from further exchange rates like the USD/JPY and/or GBP/USD rate into account. In some situations a realized potential of more than 20% was achieved. We also developed a practical trading strategy using an opening and closing threshold which obtained an average profit per trade larger than three pips. If the spread is on average below three pips this results in profitable trading. Thus, our approach seems to be able to learn the effect of technical trading tools which are commonly used in the intraday foreign exchange market. It also indicates that FX rates have an underlying process which is not purely Markovian, but seems to have additional structure and memory which we believe is caused by technical trading in the market.

Our methodology can be further refined especially in the choice of attributes and parameters. For example, we considered the same time frame for the first derivatives of all the involved currency pairs, i.e. k=9 and k=4. Using differnt time frames for the different exchange rates might result in a further improvement of the performance. Other intraday information like the variance of the exchange rates or the current spread can also be incorporated. Furthermore, we did not yet take the different interest rates into account, but their inclusion into the forecasting process can nevertheless be helpful. The time of day could also be a useful attribute since the activity in the market changes during the day [20].

In our experiments we used data from 2001 to 2005 to forecast for five months in the year 2005. Therefore, our observations are only based on this snapshot in time of the foreign exchange market. For a snapshot from an other time interval one would most likely use different features and parameters and one would achieve somewhat changed results. Furthermore, it has to be seen if today's market behaviour, which may be different especially after the recent financial crisis, can still be forecast with such an approach, or if the way the technical trading takes place has changed fundamentally. In any case, for a viable trading system, a learning approach is necessary which relearns automatically and regularly over time, since trading rules are typically valid only for a certain period.

Note finally that our approach is not limited to the FX application. In finance it may be employed for the prediction of the technical behaviour of stocks or interest rates as well. It also can be applied to more general time series problems with a large amount of data which arise in many applications in biology, medicine, physics, econometrics and computer science.

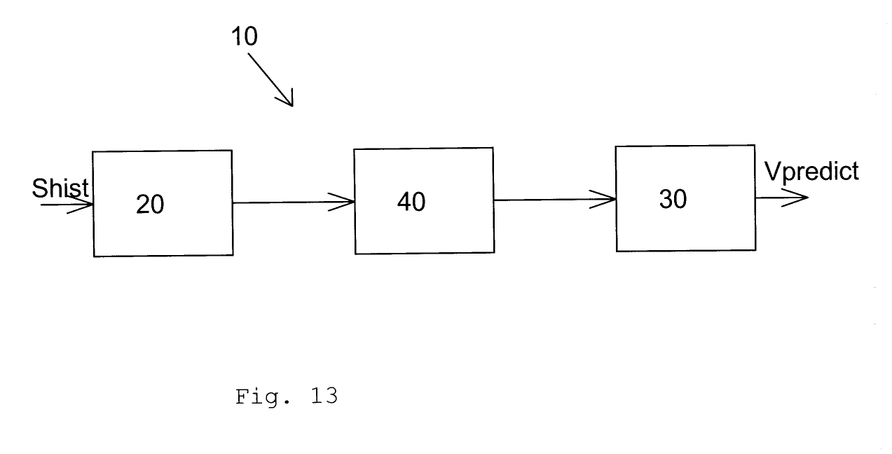

FIG. 13 shows an exemplary embodiment of a device 10 for valuation of a traded commodity. The device 10 comprises an input unit 20 which is adapted to accept an historical time series Shist of the commodity's value. Further, the device 10 comprises an output unit 30 adapted to output a predicted relative or absolute future value Vpredict of the commodity. A data processor 40 of device 10 is configured to compute the predicted future value Vpredict of the traded commodity by a determination of an expectation, based on the steps explained in detail above.

In summary the invention as described herein in an exemplary fashion, tackles the problem of forecasting intraday exchange rates by transforming it into a machine learning regression problem. The idea behind this approach is that the market will behave similarly in similar situations due to the use of technical analysis by market participants. The machine learning algorithm attempts to learn the impact of the trading rules just from the empirical behaviour of the market. To this end, the time series of transaction tick data is cast into a number of data points in a D-dimensional feature space together with a label. The label represents the difference between the exchange rates of the current time and a fixed time step into the future. Therefore one obtains a regression problem. Here, the D features are derived from a delay embedding of the data [24, 29]. For example, approximations of first or second derivatives at each time step of the exchange rate under consideration may be used. The additional use of tick data from further exchange rates improves the quality of the prediction of one exchange rate.

Delay embedding is a powerful tool to analyze dynamical systems. Taken's theorem [29] gives the conditions under which a chaotic dynamical system can be reconstructed from a sequence of observations. In essence, it states that if the state space of the dynamical system is a k-dimensional manifold, then it can be embedded in (2k+1)-dimensional Euclidean space using the 2k+1 delay values f(t), f(t−τ), f(t−2τ), . . . , f(t−2kτ). Here, heuristic computational methods, such as the Grassberger-Procaccia algorithm [14] may be used to estimate the embedding dimension k.

Embodiments of the invention may apply an approach for data mining problems as described in [10, 11]. It may be based on the regularization network formulation [13] and may use a grid, independent from the data positions, with associated local ansatz functions to discretize the feature space. This is similar to the numerical treatment of partial differential equations with finite elements. To avoid the curse of dimensionality, at least to some extent, a sparse grid [3, 34] may be used in the form of the combination technique [15]. The approach is based on a hierarchical subspace splitting and a sparse tensor product decomposition of the underlying function space. To this end, the regularized regression problem may be discretized and solved on a certain sequence of conventional grids. The sparse grid solution may then be obtained by a linear combination of the solutions from the different grids. It turns out that this method scales only linearly with the number of data points to be treated [11]. Thus, the method and system as described is well suited for machine learning applications where the dimension D of the feature space is moderately high, but the amount of data is very large, which is the case in FX forecasting. This is in contrast to support vector machines and related kernel based techniques whose cost scale quadratically or even cubically with the number of data points (but allow to deal with very high-dimensional feature spaces).

Embodiments of the invention may achieve prediction accuracies of almost 60%, profits of up to 25% of the maximum attainable profit and average revenues per transaction larger than typical transaction costs have been measured.

### REFERENCES

[1] D. J. E. Baestaens, W. M. van den Bergh, and H. Vaudrey: Market inefficiencies, technical trading and neural networks. In C. Dunis, editor, Forecasting Financial Markets, pages 245-260. Wiley, 1996.
[2] W. Brock, J. Lakonishok, and B. LeBaron: Simple technical trading rules and the stochastic properties of stock returns. The Journal of Finance, 47(5):1731-1764, 1992.
[3] H.-J. Bungartz and M. Griebel: Sparse grids. Acta Numerica, 13:147-269, 2004.
[4] Y.-W. Cheung and C. Y.-P. Wong: Foreign exchange traders in Hong Kong, Tokyo, and Singapore: A survey study. In T. Bos and T. A. Fetherston, editors, Advances in Pacific Basin Financial Markets, volume 5, pages 111-134. JAI, 1999.
[5] R. Curcio, C. Goodhart, D. Guillaume, and R. Payne: Do technical trading rules generate profits? Conclusions from the intra-day foreign exchange market. Int. J. Fin. Econ., 2(4):267-280, 1997.
[6] M. A. H. Dempster, T. W. Payne, Y. S. Romahi, and G. W. P. Thompson: Computational learning techniques for intraday FX trading using popular technical indicators. IEEE Trans. Neural Networks, 12(4):744-754, 2001.
[7] M. Engel: Time series analysis. Part III Essay, University of Cambridge, 1991.
[8] T. Evgeniou, M. Pontil, and T. Poggio: Regularization networks and support vector machines. Advances in Computational Mathematics, 13:1-50, 2000.
[9] J. Garcke: Regression with the optimised combination technique. In W. Cohen and A. Moore, editors, Proceedings of the 23rd ICML ‘06, pages 321-328, 2006.
[10] J. Garcke and M. Griebel: Classification with sparse grids using simplicial basis functions. Intelligent Data Analysis, 6(6):483-502, 2002.
[11] J. Garcke, M. Griebel, and M. Thess: Data mining with sparse grids. Computing, 67(3):225-253, 2001.
[12] J. Garcke and M. Hegland: Fitting multidimensional data using gradient penalties and the sparse grid combination technique. Computing, 84(1-2):1-25, April 2009.
[13] F. Girosi, M. Jones, and T. Poggio: Regularization theory and neural networks architectures. Neural Computation, 7:219-265, 1995.
[14] P. Grassberger and I. Procaccia: Characterization of strange attractors. Phys. Rev. Lett, 50:346-349, 1983.
[15] M. Griebel, M. Schneider, and C. Zenger: A combination technique for the solution of sparse grid problems. In P. de Groen and R. Beauwens, editors, Iterative Methods in Linear Algebra, pages 263-281. IMACS, Elsevier, North Holland, 1992.
[16] D. M. Guillaume, M. M. Dacorogna, R. R. Dave, U. A. Muller, R. B. Olsen, and O. V. Pictet: From the bird's eye to the microscope: A survey of new stylized facts of the intra-daily foreign exchange markets. Finance Stochast., 1(2):95-129, 1997.
[17] M. Hegland, J. Garcke, and V. Challis: The combination technique and some generalisations. Linear Algebra and its Applications, 420(2-3):249-275, 2007.
[18] M. Hegland, O. M. Nielsen, and Z. Shen. Multidimensional smoothing using hyperbolic interpolatory wavelets. Electronic Transactions on Numerical Analysis, 17:168-180, 2004.
[19] I. Horenko: Finite element approach to clustering of multidimensional time series. SIAM Journal on Scientific Computing, 2008, to appear.
[20] K. Iwatsubo and Y. Kitamura: Intraday evidence of the informational efficiency of the yen/dollar exchange rate. Applied Financial Economics, 19(14):1103-1115, 2009.
[21] H. Kantz and T. Schreiber: Nonlinear time series analysis. Cambridge University Press, 1997.
[22] K. Lien: Day Trading the Currency Market. Wiley, 2005.
[23] Y.-H. Lui and D. Mole: The use of fundamental and technical analyses by foreign exchange dealers: Hong Kong evidence. J. Int. Money Finance, 17(3):535-545, 1998.
[24] A. L. M. Verleysen, E. de Bodt: Forecasting financial time series through intrinsic dimension estimation and non-linear data projection. In J. Mira and J. V. Sanchez-Andres, editors, Engineering Applications of Bio-Inspired Artificial Neural Networks, Volume II, volume 1607 of Lecture Notes in Computer Science, pages 596-605. Springer, 1999.
[25] C. J. Neely and P. A. Weller: Intraday technical trading in the foreign exchange market. J. Int. Money Finance, 22(2):223-237, 2003.
[26] C. Osler: Support for resistance: Technical analysis and intraday exchange rates. Economic Policy Review, 6(2):53-68, 2000.
[27] T. R. Reid: The United States of Europe, The New Superpower and the End of the American Supremacy. Penguin Books, 2004.
[28] B. Scholkopf and A. Smola: Learning with Kernels. MIT Press, 2002.
[29] F. Takens: Detecting strange attractors in turbulence. In D. Rand and L.-S. Young, editors, Dynamical Systems and Turbulence, volume 898 of Lecture Notes in Mathematics, pages 366-381. Springer, 1981.
[30] M. P. Taylor and H. Allen: The use of technical analysis in the foreign exchange market. J. Int. Money Finance, 11(3):304-314, 1992.
[31] A. N. Tikhonov and V. A. Arsenin: Solutions of illposed problems. W. H. Winston, Washington D.C., 1977.
[32] G. Tsibouris and M. Zeidenberg: Testing the efficient markets hypothesis with gradient descent algorithms. In A.-P. Refenes, editor, Neural Networks in the Capital Markets, chapter 8, pages 127-136. Wiley, 1995.
[33] G. Wahba: Spline models for observational data, volume 59 of Series in Applied Mathematics. SIAM, Philadelphia, 1990.
[34] C. Zenger: Sparse grids. In W. Hackbusch, editor, Parallel Algorithms for Partial Differential Equations, Proceedings of the Sixth GAMM-Seminar, Kiel, 1990, volume 31 of Notes on Num. Fluid Mech. Vieweg-Verlag, 1991.
[35] H. G. Zimmermann, R. Neuneier, and R. Grothmann: Multi-agent modeling of multiple FX-markets by neural networks. IEEE Trans. Neural Networks, 12(4):735-743, 2001. 18

1. A method for valuation of a traded commodity by a data processor, wherein a relative or absolute future value of the traded commodity is computed by a determination of an expectation by the data processor, the method comprising the steps of:
receiving a historical time series indicating the commodity's value over time in the data processor;
transferring the historical time series of the commodity's value into attribute values of at least one attribute representative for internal features of the historical time series; and
constructing a function predicting the future value of the commodity based on a sparse grid regression method which takes said attribute values into account.

2. The method of claim 1 wherein said step of transferring the historical time series of the commodity's value into attribute values includes generating data describing the temporal changes of the historical time series.

3. The method of claim 2 wherein said data describing the temporal changes of the historical time series are calculated for at least two different time scales.

4. The method of claim 1 wherein said step of transferring the historical time series of the commodity's value into attribute values includes calculating at least one derivative of first or higher degree of the historical time series.

5. The method of claim 1 wherein said step of transferring the historical time series of the commodity's value into attribute values includes calculating a variance indicating the magnitude of change of the historical time series values over time.

6. The method of claim 1 wherein said step of transferring the historical time series of the commodity's value into attribute values includes calculating higher order standardized moments indicating the behavior of the change of the historical time series values over time.

7. The method of claim 1 wherein said step of transferring the historical time series of the commodity's value into attribute values includes calculating one or more moving average for a selected time window indicating the change of the historical time series values over time.

8. The method of claim 1 wherein said step of transferring the historical time series of the commodity's value into attribute values includes calculating the buy/sell spread indicating the liquidity of the market and size of the transaction cost for the traded commodity.

9. The method of claim 1 wherein said step of transferring the historical time series of the commodity's value into attribute values includes calculating one or more open-high-low-close values, which is the price range (the highest and lowest prices) over one unit of time, for a selected time window indicating the movement of the historical time series values over time.

10. The method of claim 1 wherein values of at least a second commodity is taken into account.

11. The method of claim 10 further comprising the steps of:
transferring a second historical time series of values of the second commodity into attribute values of at least one attribute representative for internal features of the secand historical time series; and
constructing said function predicting the future value of the commodity based on a sparse grid regression method which further takes the attribute values of the second time series into account.

12. The method of claim 11 wherein a further function describing the future value of the second commodity is calculated based on a sparse grid regression method which takes the attribute values of the historical time series of the commodity and the attribute values of the second historical time series of the second commodity into account.

13. The method of claim 1 wherein the predicted future commodity's value is communicated as at least one of a digital signal and an analog signal, and the value is displayed on at least one of a monitor and an output device.

14. The method of claim 1 wherein said sparse grid regression function is evaluated during processing of electronic training data, wherein a sparse grid regression function is applied to a set of electronic evaluation data and a quality value indicating the quality of the prediction by said sparse grid regression function is evaluated.

15. The method of claim 14 wherein the future value of the commodity is evaluated based on said sparse grid regression function if said quality value exceeds a predefined threshold.

16. A method for generating a recommendation signal indicating a recommendation to buy or sell a commodity by a data processor, the method comprising the steps of:
receiving an historical time series of the commodity's value in the data processor;
transferring the historical time series of the commodity's value into attribute values of at least one attribute representative for internal features of the historical time series;
constructing a function predicting a relative or absolute future value of the commodity based on a sparse grid regression method which takes said attribute values into account; and
generating said recommendation signal if the increase or decrease of the predicted future value of the traded commodity exceeds a predefined threshold.

17. A device for valuation of a traded commodity comprising:
an input unit adapted to accept an historical time series of the commodity's value;
an output unit adapted to output a predicted relative or absolute future value of the commodity; and
a data processor configured to compute the predicted future value of the traded commodity by a determination of an expectation, based on the following steps:
receiving the historical time series of the commodity's value from the input unit;
transferring the historical time series of the commodity's value into attribute values of at least one attribute representative for internal features of the historical time series; and
constructing a function predicting the future value of the commodity based on a sparse grid regression method which takes said attribute values into account.
